(19) United States
(12) Patent Application Publication
(10) Pub. No.: US 2026/0342227 A1
(43) Pub. Date: Oct. 29, 2026

(54) THREE-LEVEL BUCK CONVERTER WITH IMPROVED TRANSIENT RESPONSE

(71) Applicant: QUALCOMM Incorporated, San Diego, CA (US)

(72) Inventors: Sanghwa JUNG, Los Gatos, CA (US); Joseph Dale RUTKOWSKI, Chandler, AZ (US); Ta-Tung YEN, Cupertino, CA (US); Ahmed ABDELMOATY, San Jose, CA (US)

(21) Appl. No.: 19/187,130

(22) Filed: Apr. 23, 2025

(51) Int. Cl. H02M 3/158

(52) U.S. Cl. CPC H02M 3/158

(57) ABSTRACT

Certain aspects of the present disclosure are directed towards a power supply circuit. The power supply circuit generally includes: a three-level buck converter comprising a first transistor and a second transistor coupled between an input voltage (VIN) node and a switching voltage (VSW) node, a third transistor and a fourth transistor coupled between the VSW node and a reference potential node, and an inductive element coupled between the VSW node and an output voltage (VOUT) node; and a controller configured to: identify an occurrence of an event associated with a load of the three-level buck converter; turn on the first transistor and the second transistor for at least one first cycle based on the occurrence of the event; and turn on the second transistor and the fourth transistor for a second cycle after the at least one first cycle.

### TECHNICAL FIELD

Certain aspects of the present disclosure generally relate to electronic circuits and, more particularly, to a power supply circuit.

### BACKGROUND

A voltage regulator provides a constant direct current (DC) output voltage regardless of changes in load current or input voltage. Voltage regulators may be classified as either linear regulators or switching regulators. While linear regulators tend to be small and compact, many applications may benefit from the increased efficiency of a switching regulator. A linear regulator may be implemented by a low-dropout (LDO) regulator, for example. A switching regulator may be implemented by a switched-mode power supply (SM PS), such as a buck converter, a boost converter, a buck-boost converter, or a charge pump.

For example, a buck converter is a type of SM PS typically comprising: (1) a high-side switch coupled between a relatively higher voltage rail and a switching node, (2) a low-side switch coupled between the switching node and a relatively lower voltage rail, (3) and an inductor coupled between the switching node and a load (e.g., represented by a shunt capacitive element). The high-side and low-side switches may be implemented with transistors, although the low-side switch may alternatively be implemented with a diode.

Power management integrated circuits (power management ICs or PM ICs) are used for managing the power demands of a host system and may include and/or control one or more voltage regulators (e.g., buck converters or charge pumps). A PMIC may be used in battery-operated devices, such as mobile phones, tablets, laptops, wearables, etc., to control the flow and direction of electrical power in the devices. The PM IC may perform a variety of functions for the device such as DC-to-DC conversion (e.g., using a voltage regulator as described above), battery charging, power-source selection, voltage scaling, power sequencing, etc.

### SUMMARY

The systems, methods, and devices of the disclosure each have several aspects, no single one of which is solely responsible for its desirable attributes. Without limiting the scope of this disclosure as expressed by the claims that follow, some features will now be discussed briefly. After considering this discussion, and particularly after reading the section entitled “Detailed Description,” one will understand how the features of this disclosure provide the advantages described herein.

Certain aspects of the present disclosure are directed towards a power supply circuit. The power supply circuit generally includes: a three-level buck converter comprising a first transistor and a second transistor coupled between an input voltage (VIN) node and a switching voltage (VSW) node, a third transistor and a fourth transistor coupled between the VSW node and a reference potential node, and an inductive element coupled between the VSW node and an output voltage (VOUT) node; and a controller configured to: identify an occurrence of an event associated with a load of the three-level buck converter; turn on the first transistor and the second transistor for at least one first cycle based on the occurrence of the event; and turn on the second transistor and the fourth transistor for a second cycle after the at least one first cycle.

Certain aspects of the present disclosure are directed towards a method of controlling a power supply circuit, comprising: identifying an occurrence of an event associated with a load of a three-level buck converter, the three-level buck converter comprising a first transistor and a second transistor coupled between an input voltage (VIN) node and a switching voltage (VSW) node, a third transistor and a fourth transistor coupled between the VSW node and a reference potential node, and an inductive element coupled between the VSW node and an output voltage (VOUT) node; turning on the first transistor and the second transistor for at least one first cycle based on the occurrence of the event; and turning on the second transistor and the fourth transistor for a second cycle after the at least one first cycle.

Certain aspects of the present disclosure are directed towards a three-level buck converter. The three-level buck converter generally includes: a first transistor and a second transistor coupled between an input voltage (VIN) node and a switching voltage (VSW) node; a third transistor and a fourth transistor coupled between the VSW node and a reference potential node; and an inductive element coupled between the VSW node and an output voltage (VOUT) node, wherein: the first transistor and the second transistor are configured to be turned on for at least one first cycle based on identifying an occurrence of an event associated with a load of the three-level buck converter; and the second transistor and the fourth transistor are configured to be turned on for a second cycle after the at least one first cycle.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates a block diagram of an example device that includes a power supply system with at least one switched-mode power supply (SM PS) circuit, in accordance with certain aspects of the present disclosure.

FIG. 2 is a block diagram of an example power supply scheme comprising a battery charging circuit, a battery circuit, and a pre-regulator for regulating power to one or more voltage regulators, in accordance with certain aspects of the present disclosure.

FIG. 3 is a circuit diagram of an example adaptive SM PS circuit, in accordance with certain aspects of the present disclosure.

FIG. 4 is a timing diagram illustrating example states of transistors of a power supply circuit.

FIG. 5 is a timing diagram illustrating example states of transistors of a power supply circuit to increase a transient response of the power supply circuit, in accordance with certain aspects of the present disclosure.

FIG. 6 is a flow diagram illustrating example operations for controlling a power supply circuit, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Certain aspects of the present disclosure are directed toward techniques and apparatus for enhancing the recovery of an output voltage (VOUT) in a three-level buck converter. A controller may apply an input voltage (VIN) at a VIN node of the converter directly to a switching voltage (VSW) node of the converter as opposed to the VIN node being coupled to the VSW node through a flying capacitive element (CFLY) of the converter. For example, in response to an occurrence of an event indicating increased load current draw (e.g., which may result in VOUT dropping below a threshold), a controller may turn on transistors Q1 and Q2 of the converter during one or more cycles, increasing the slope at which the inductor current of the converter increases. In this manner, current can be more quickly provided to the output of the converter to feed the increased current demand from the load, recovering VOUT back to a target voltage and improving the transient response of the converter (e.g., increasing the converter's regulation response speed to transient load conditions). After the one or more cycles, the controller may revert to normal switching operations to avoid the VOUT from overshooting a target voltage.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

As used herein, the term “connected with” in the various tenses of the verb “connect” may mean that element A is directly connected to element B or that other elements may be connected between elements A and B (i.e., that element A is indirectly connected with element B). In the case of electrical components, the term “connected with” may also be used herein to mean that a wire, trace, or other electrically conductive material is used to electrically connect elements A and B (and any components electrically connected therebetween).

### An Example Device

It should be understood that aspects of the present disclosure may be used in a variety of applications. Although the present disclosure is not limited in this respect, the circuits disclosed herein may be used in any of various suitable apparatus, such as in the power supply, battery charging circuit, or power management circuit of a communication system, a video codec, audio equipment such as music players and microphones, a television, camera equipment, and test equipment such as an oscilloscope. Communication systems intended to be included within the scope of the present disclosure include, by way of example only, cellular radiotelephone communication systems, satellite communication systems, two-way radio communication systems, one-way pagers, two-way pagers, personal communication systems (PCSs), personal digital assistants (PDAs), and the like.

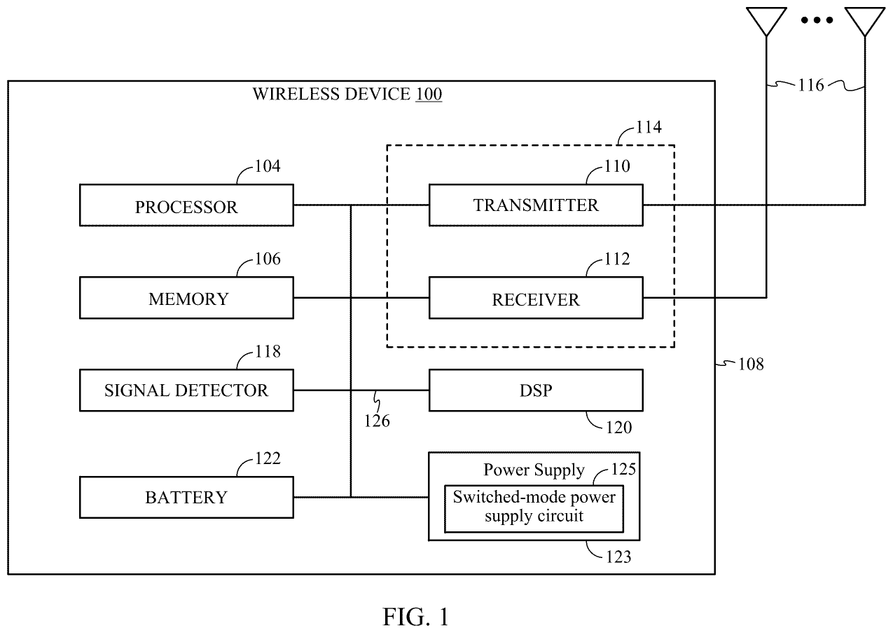

FIG. 1 illustrates an example device 100 in which aspects of the present disclosure may be implemented. The device 100 may be a battery-operated device such as a cellular phone, a PDA, a handheld device, a wireless device, a laptop computer, a tablet, a smartphone, a wearable device, etc.

The device 100 may include a processor 104 that controls operation of the device 100. The processor 104 may also be referred to as a central processing unit (CPU). Memory 106, which may include both read-only memory (ROM) and random access memory (RAM), provides instructions and data to the processor 104. A portion of the memory 106 may also include non-volatile random access memory (NVRAM). The processor 104 typically performs logical and arithmetic operations based on program instructions stored within the memory 106.

In certain aspects, the device 100 may also include a housing 108 that may include a transmitter 110 and a receiver 112 to allow transmission and reception of data between the device 100 and a remote location. For certain aspects, the transmitter 110 and receiver 112 may be combined into a transceiver 114. One or more antennas 116 may be attached or otherwise coupled to the housing 108 and electrically connected to the transceiver 114. The device 100 may also include (not shown) multiple transmitters, multiple receivers, and/or multiple transceivers.

The device 100 may also include a signal detector 118 that may be used in an effort to detect and quantify the level of signals received by the transceiver 114. The signal detector 118 may detect such signal parameters as total energy, energy per subcarrier per symbol, and power spectral density, among others. The device 100 may also include a digital signal processor (DSP) 120 for use in processing signals.

The device 100 may further include a battery 122 used to power the various components of the device 100. The device 100 may also include a power supply system 123 for managing the power from the battery to the various components of the device 100. At least a portion of the power supply system 123 may be implemented in one or more power management integrated circuits (power management ICs or PM ICs) The power supply system 123 may perform a variety of functions for the device 100 such as DC-to-DC conversion, battery charging, power-source selection, voltage scaling, power sequencing, etc. For example, the power supply system 123 may include a battery charging circuit (e.g., a master-slave battery charging circuit) for charging the battery 122. The power supply system 123 includes one or more power supply circuits, which may include a switched-mode power supply circuit 125. The switched-mode power supply circuit 125 may be implemented by any of various suitable switched-mode power supply circuit topologies, such as a three-level buck converter. In some aspects, the three-level buck converter may directly apply an input voltage (VIN) of the converter to a switching voltage (VSW) node upon occurrence of an event indicating increased current draw from a load, as described in more detail herein.

The various components of the device 100 may be coupled together by a bus system 126, which may include a power bus, a control signal bus, and/or a status signal bus in addition to a data bus. Additionally or alternatively, various combinations of the components of the device 100 may be coupled together by one or more other suitable techniques.

### Example Power Supply Scheme

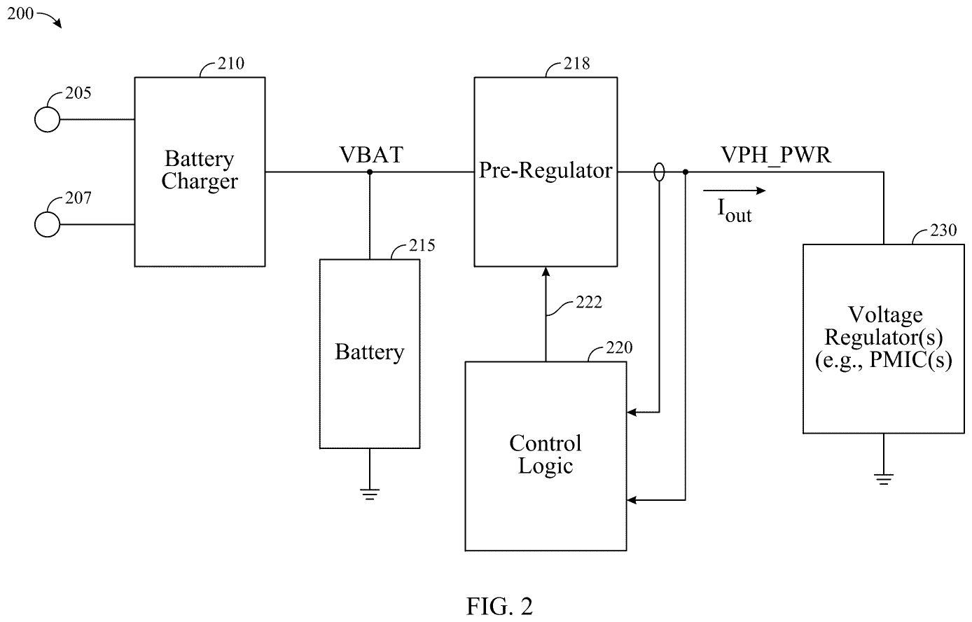

FIG. 2 is a block diagram of an example power supply scheme 200, in accordance with certain aspects of the present disclosure. The power supply scheme 200 includes a battery charging circuit 210, a battery circuit 215, a pre-regulator 218, and one or more voltage regulators 230. Control logic 220 may receive various inputs (e.g., voltage and/or current feedback signals) and may control the pre-regulator 218, the battery charging circuit 210, and/or the voltage regulators 230.

The battery charging circuit 210 may receive power from one or more ports (e.g., ports 205 and 207), and this received power may be converted and used to charge a battery or a battery pack in a battery circuit 215 of a portable device (e.g., a smartphone, tablet, and the like). For example, port 205 may be a Universal Serial Bus (USB) port for connecting to a wall adapter, whereas port 207 may be a wireless power port. The battery circuit 215 may include a single-cell or multi-cell-in-series battery (e.g., a two-cell-in-series, or 2S, battery). The battery circuit 215 may also include any protection circuitry, which may include switches implemented by transistors, for example. For certain aspects, the battery charging circuit 210, or at least a portion thereof, may reside in a PM IC in the device. The battery charging circuit 210 may comprise, for example, one or more switched-mode power supplies (e.g., a buck converter and/or a charge pump converter). For certain aspects, the battery charging circuit may comprise two or more parallel charging circuits, each capable of charging the battery, which may be connected together and to the battery in an effort to provide fast charging of the battery. The parallel charging circuits may be configured so that these circuits do not adversely interfere with each other during battery charging (e.g., in a master-slave relationship). Charging circuits for a parallel charger may use buck converter topologies, such as a three-level buck converter topology. However, one or more of the buck converters may be replaced with a charge pump converter in some parallel charging circuits.

The pre-regulator 218 may receive power from the battery with a voltage VBAT (e.g., 7 to 9 V). Used to regulate power for the voltage regulators 230, the pre-regulator 218 may comprise, for example, one or more switched-mode power supplies (e.g., a buck converter, a charge pump converter, or an adaptive combination power supply circuit capable of switching therebetween). As described below, the control logic 220 may receive an indication of a current associated with the pre-regulator 218 (e.g., output current Iout) and an indication of the output voltage VPH_PWR (e.g., 3.3 to 4 V) from the pre-regulator. Based, at least in part, on these indications, the control logic 220 may output one or more control signals 222 to control the pre-regulator 218. For example, in the case of a three-level buck converter topology, the control logic 220 may output signals as inputs to the gate drivers for driving the power transistors to regulate the output voltage VPH_PWR. The one or more voltage regulators 230 may include one or more linear regulators and/or one or more switching regulators for generating smaller voltages (e.g., 1.2 to 3.3 V) from VPH_PWR. For certain aspects, the voltage regulators 230 may include core PMICs for the device.

### Example Power Supply Circuits and Operation

As described above, a pre-regulator (e.g., the pre-regulator 218) may be implemented by a switched-mode power supply (e.g., a buck converter, a charge pump converter, or an adaptive combination power supply circuit capable of switching therebetween), which may be a single-phase or multi-phase converter. In the case of an adaptive combination power supply circuit, both converter modes may be single-phase, both converter modes may be multi-phase, one converter mode may be single-phase while the other converter mode is multi-phase or capable of changing between single-phase and multi-phase, or one converter mode may be multi-phase while the other converter mode is capable of changing between single-phase and multi-phase.

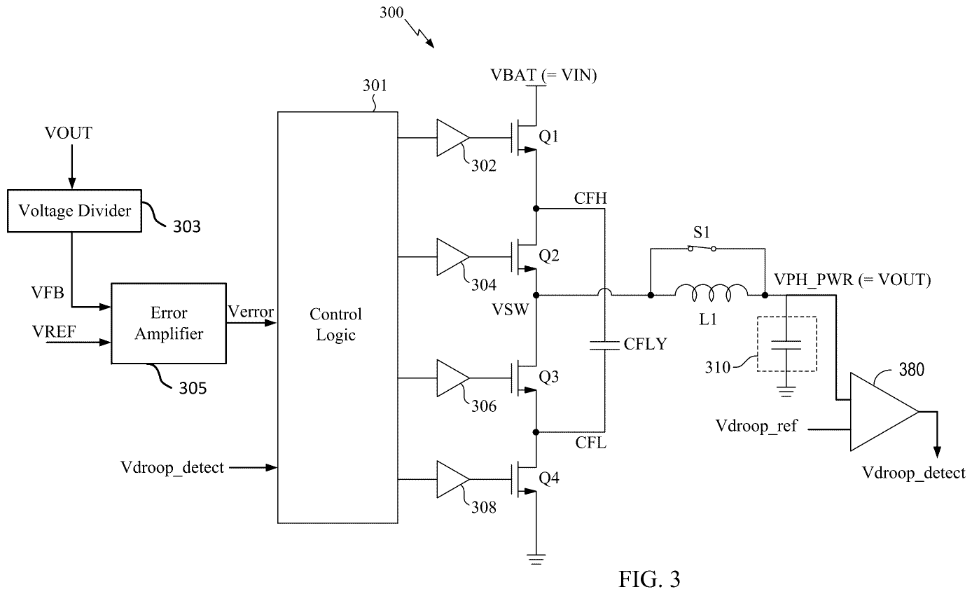

A single-phase three-level buck converter topology (as illustrated in the power supply circuit 300 of FIG. 3) may include a first transistor Q1, a second transistor Q2, a third transistor Q3, a fourth transistor Q4, a flying capacitive element CFLY, an inductive element L1, and a load 310, which is represented here by a capacitor. An adaptive combination power supply circuit may be realized by adding a switch S1 across the inductive element L1 of the three-level buck converter topology. With the switch S1 closed, the adaptive combination power supply circuit may function as a single-phase divide-by-two (Div2) charge pump converter, as further described below.

Transistor Q2 may be coupled to transistor Q1 via a first node (labeled “CFH” for flying capacitor high node), transistor Q3 may be coupled to transistor Q2 via a second node (labeled “VSW” for voltage switching node), and transistor Q4 may be coupled to transistor Q3 via a third node (labeled “CFL” for flying capacitor low node). For certain aspects, the transistors Q1-Q4 may be implemented as n-type metal-oxide-semiconductor (NM OS) transistors, as illustrated in FIG. 3. In this case, the drain of transistor Q2 may be coupled to the source of transistor Q1, the drain of transistor Q3 may be coupled to the source of transistor Q2, and the drain of transistor Q4 may be coupled to the source of transistor Q3. The source of transistor Q4 may be coupled to a reference potential node (e.g., electric ground) for the power supply circuit 300. The flying capacitive element CFLY may have a first terminal coupled to the first node and a second terminal coupled to the third node. The inductive element L1 may have a first terminal coupled to the second node and a second terminal coupled to an output voltage node (labeled “VPH_PWR,” but also referred to as “VOUT”) and the load 310.

Control logic 301 may control operation of the power supply circuit 300 and may be the same or different from control logic 220 in FIG. 2. For example, control logic 301 may control operation of the transistors Q1-Q4 via output signals to the inputs of respective gate drivers 302, 304, 306, and 308. The outputs of the gate drivers 302, 304, 306, and 308 are coupled to respective gates of transistors Q1-Q4. During operation of the power supply circuit 300, the control logic 301 may cycle through four different phases, which may differ depending on whether the duty cycle is less than 50% or greater than 50%.

As shown, the power supply circuit 300 may include an error amplifier 305 that receives a feedback voltage (VFB). VFB may be generated based on (e.g., may be a fraction of) VOUT using a voltage divider 303, in some cases. The error amplifier 305 may also receive a reference voltage (V REF) which may represent a target for VOUT. The error amplifier 305 may generate an error voltage (V error) that represents the error between the actual VOUT and the target for VOUT, based on which the control logic 301 may control the transistors Q1-Q4 such that VOUT is regulated to be equal to the target for VOUT (e.g., until VFB is equal to VREF).

Operation of the power supply circuit 300 with a duty cycle of less than 50% is described first. In a first phase (referred to as a “charging phase”), transistors Q1 and Q3 are activated, and transistors Q2 and Q4 are deactivated, to charge the flying capacitive element CFLY and to energize the inductive element L1. In a second phase (called a “holding phase” or a “freewheeling phase”), transistor Q1 is deactivated, and transistor Q4 is activated, such that the VSW node is coupled to the reference potential node, the flying capacitive element CFLY is disconnected (e.g., one of the CFLY terminals is floating), and the inductive element L1 is deenergized. In a third phase (referred to as a “discharging phase”), transistors Q2 and Q4 are activated, and transistor Q3 is deactivated, to discharge the flying capacitive element CFLY and to energize the inductive element L1. In a fourth phase (also referred to as a “holding phase”), transistor Q3 is activated, and transistor Q2 is deactivated, such that the flying capacitive element CFLY is disconnected and the inductive element L1 is deenergized.

Operation of the power supply circuit 300 with a duty cycle greater than 50% is similar in the first and third phases, with the same transistor configurations. However, in the second phase (called a “holding phase”) following the first phase, transistor Q3 is deactivated, and transistor Q2 is activated, such that the VSW node is coupled to an input voltage node (labeled “VBAT,” but also referred to as “VIN”), the flying capacitive element CFLY is disconnected, and the inductive element L1 is energized. Similarly in the fourth phase (also referred to as a “holding phase”) with a duty cycle greater than 50%, transistor Q1 is activated, and transistor Q4 is deactivated, such that the flying capacitive element CFLY is disconnected and the inductive element L1 is energized.

Furthermore, the control logic 301 has a control signal (not shown in FIG. 3) configured to control operation of switch S1 and selectively enable divide-by-two (Div2) charge pump operation. For certain aspects, when this control signal is logic low, switch S1 is open, and the power supply circuit 300 operates as a three-level buck converter using the inductive element L1. When this control signal is logic high for certain aspects, switch S1 is closed, thereby shorting across the inductive element L1 and effectively removing the inductive element L1 from the circuit, such that the power supply circuit 300 operates as a Div2 charge pump. The control logic 301 may be configured to automatically control operation of switch S1 (e.g., through the logic level of the control signal) based on at least one of an output current (also referred to as a “load current”) or an input current for the power supply circuit 300.

### Example Techniques for Voltage Balancing

As described, in a first phase (referred to as a “charging phase”), transistors Q1 and Q3 are activated (turned on), and transistors Q2 and Q4 are deactivated (turned off), to charge the flying capacitive element CFLY and to energize the inductive element L1. During the charging phase, the inductor current (e.g., current across inductive element L1 of FIG. 3) rises. The rising slope of the inductor current (IL slope) may be calculated per equation:

$$IL slope = \frac{VIN / 2 - VOUT}{L}$$

where L is the inductance of inductive element L1. As shown, the IL slope may be set (e.g., limited) by the voltage at the VSW node which may be equal to VIN/2 during the charging phase.

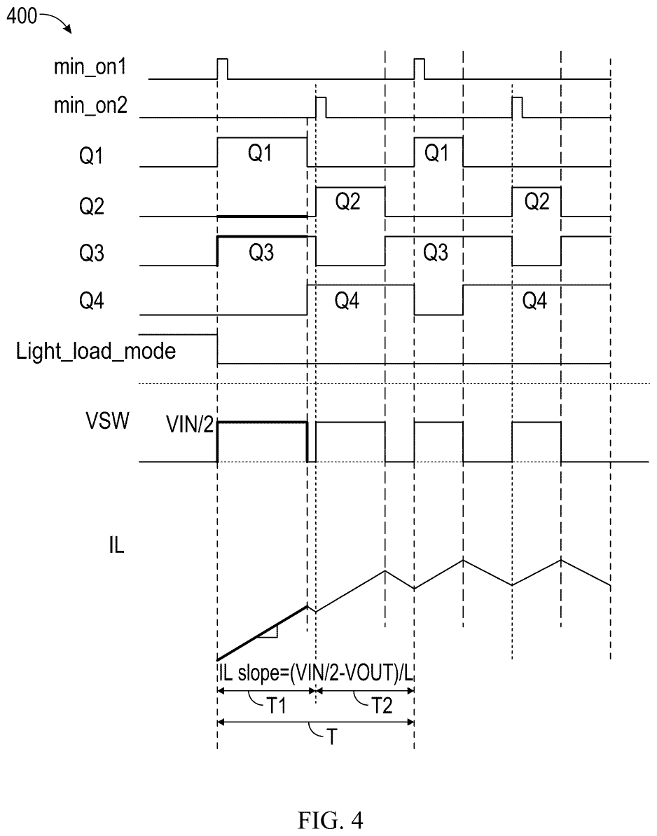

FIG. 4 is a timing diagram 400 illustrating example states of transistors of a power supply circuit (e.g., a three-level buck converter such as the power supply circuit 300) when operating with a duty cycle of less than 50%. As shown, during a time duration T1, the three-level buck converter may be operated in a charging phase during which transistors Q1 and Q3 are turned on followed by a freewheeling phase during which transistors Q3 and Q4 are turned on. During a time duration T2, the three-level buck converter may also be operated in a discharging phase during which transistors Q2 and Q4 are turned on followed by another freewheeling phase. The charging phase, the freewheeling phase, the discharging phase, and the other freewheeling phase may be repeated with a period T. The inductor current increases with the IL slope during the charging and discharging phases.

The power supply circuit may receive a minimum on-time signal (labeled “min_on1”) for transistor Q1 and a minimum on-time signal (labeled “min_on2”) for transistor Q2. Once turned on, the min_on1 and min_on2 signals set the minimum amount of time respective transistors Q1 and Q2 are to be on before being turned off. Moreover, the min_on1 and min_on2 signals trigger when respective transistors Q1 and Q2 are to be turned on. For example, as shown, transistor Q1 is turned on at the rising edge of the min_on1 signal and the transistor Q2 is turned on at the rising edge of the min_on2 signal.

In some scenarios, the power supply circuit may transition to a light load mode of operation during which the min_on1 and min_on2 signals may be deactivated (e.g., remain logic low) such that the transistors Q1, Q2, Q3, and Q4 stop switching. As described with respect to FIG. 3, the power supply circuit may include an error amplifier 305 that generates an error voltage (Verror) based on a feedback voltage (VFB) and reference voltage (VREF). When Verror drops below some threshold, the power supply circuit may enter the light load mode by setting a light_load_mode signal to logic high as shown in timing diagram 400 of FIG. 4.

When exiting the light load mode (e.g., when light_load_mode signal transitions from logic high to logic low), transistors Q1 and Q3 are turned on for a first cycle (e.g., during a charging phase, which may be a portion of duration T1). Duration T1 may include the charging phase (e.g., during which transistors Q1 and Q3 are turned on) and a freewheeling phase (e.g., during which transistors Q3 and Q4 are turned on).

After the freewheeling phase, transistors Q2 and Q4 are turned on for a second cycle (e.g., a portion of duration T2), as shown. When transistors Q1 and Q3 are turned on during the charging phase and when transistors Q2 and Q4 are turned on during the discharging phase, the voltage at the VSW node is set to VIN/2 (e.g., VIN minus the CFLY voltage which is VIN/2), limiting the rising slope of the inductor current, as described herein.

Certain aspects of the present disclosure are directed toward increasing the inductor current's rising slope to improve the transient response of the three-level buck converter (e.g., increase the transient response speed). The rising slope of the inductor current may be increased by turning on transistors Q1 and Q2 to set the voltage at the VSW node to VIN, increasing the voltage difference across the inductive element L1 (e.g., from VIN/2−VOUT as described with respect to FIG. 4 to VIN−VOUT).

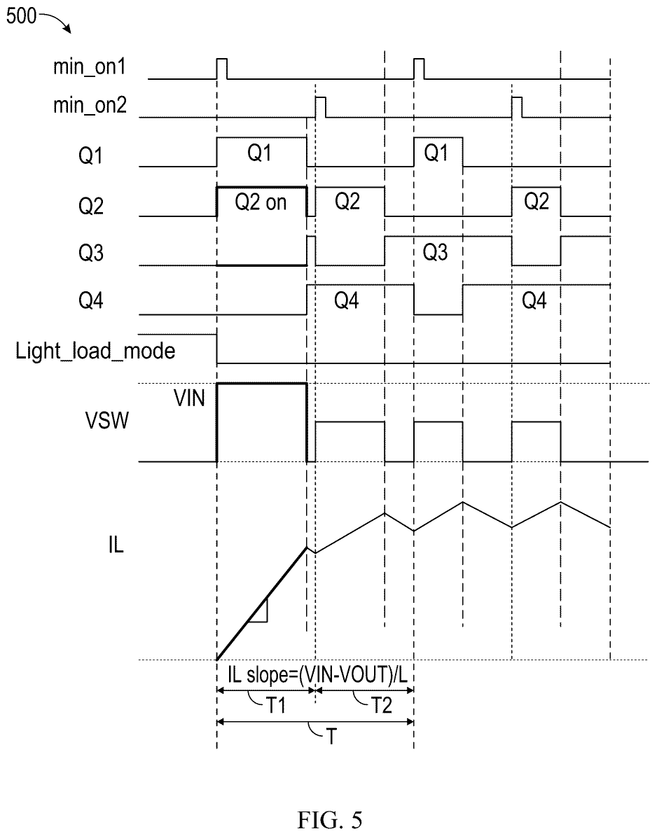

FIG. 5 is a timing diagram 500 illustrating example states of transistors of a power supply circuit (e.g., three-level buck converter such as the power supply circuit 300) with increased inductor current rising slope, in accordance with certain aspects of the present disclosure. Upon the occurrence of a certain event (e.g., condition), the transistors Q1 and Q2 are both turned on during the first cycle (e.g., at least a portion of duration T1), coupling the VSW node to the VIN. Thus, the IL slope may be increased where the IL slope may be calculated per equation:

$$IL slope = \frac{VIN - VOUT}{L}$$

Thus, the inductor current slope may be increased since VIN is applied to the VSW node. During and after the second cycle, the power supply circuit may be operated as normal (e.g., as described with respect to FIGS. 3 and 4) with a freewheeling phase, followed by a discharging phase (e.g., where transistors Q2 and Q4 are turned, discharging CFLY) to avoid VOUT overshooting a target for VOUT.

In some aspects, the condition based on which the control logic 301 turns on transistors Q1 and Q2 may include exiting the light load mode (e.g., the light_load_mode signal transitioning from logic high to load low). As described, exiting light load mode suggests that the current draw from the load of the buck converter has increased. Therefore, the control logic 301 may turn on both the transistors Q1 and Q2 during at least one cycle of the buck converter as described herein, increasing the IL slope to feed the increased current draw from the load.

The durations T1 and T2 in the timing diagram 500 may be the same as respective durations T1 and T2 in the timing diagram 400. The increased IL slope results in the inductor current reaching a higher level at the end of duration T1 in timing diagram 500 as compared to the end of duration T1 in timing diagram 400, allowing the load to draw more current.

In some aspects, the condition may be a detected voltage drop (e.g., also referred as a “voltage droop”). As described with respect to FIG. 3, a feedback voltage (VFB) may be generated using VOUT and provided to the error amplifier 305 to generate an error voltage (V error). However, the error amplifier 305 may be implemented as an integrator, which has some delay in how quickly Verror reacts to changes in VOUT. While voltage droop may be detected using Verror, the detected voltage droop may be delayed due to the delay associated with the error amplifier 305. Therefore, in some aspects, the power supply circuit 300 may include a comparator 380 with an input coupled to the VOUT node, another input receiving a reference droop voltage (Vdroop_ref), and an output coupled to the control logic 301, as illustrated in FIG. 3. Vdroop_ref may be set to a voltage below the target for VOUT. For example, Vdroop_ref may track but be less than the target for VOUT by a certain voltage difference. When there is a load attack (e.g., high current draw from a load of the buck converter), VOUT may drop below Vdroop_ref. VOUT dropping below Vdroop_ref results in the output voltage (Vdroop_detect) of the comparator 380 changing logic states, based on which the control logic 301 may turn on both the transistors Q1 and Q2 during at least one cycle of the buck converter as described herein, increasing the IL slope to feed the increased current draw from the load.

Any other suitable condition or event that indicates an increase in current draw from the load of the buck converter may be used. For example, the actual current drawn from the load or across the inductive element L1 may be measured. If the current draw exceeds some threshold, the control logic 301 may turn on both the transistors Q1 and Q2 during at least one cycle of the buck converter, as described herein.

Certain aspects improve the transient response of the buck converter by increasing the inductor current slope. As described, the inductor current slope may be increased by turning on transistors Q1 and Q2 for one or more cycles of the converter. When transistor Q2 turns on with transistor Q1, VSW is set to be equal to VIN, increasing the inductor current rising slope.

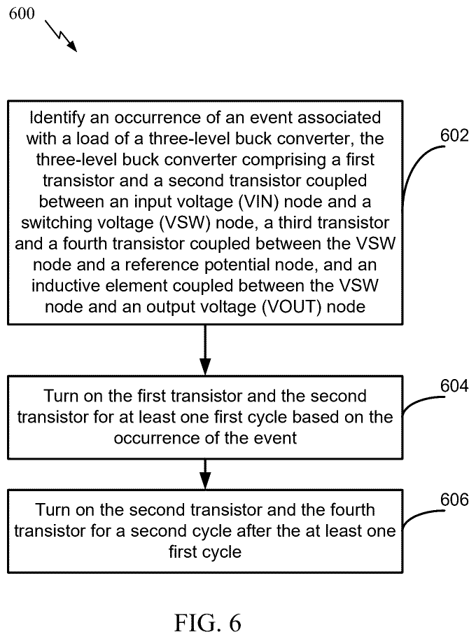

FIG. 6 is a flow diagram illustrating example operations 600 for controlling a power supply circuit, in accordance with certain aspects of the present disclosure. The operations 600 may be performed, for example, by a controller such as the control logic 301, error amplifier 305, and/or comparator 380 of FIG. 3.

At block 602, the controller identifies an occurrence of an event associated with a load of a three-level buck converter. The event may be associated with an increase in current draw from the load. The three-level buck converter may include a first transistor (e.g., transistor Q1 of FIG. 3) and a second transistor (e.g., transistor Q2 of FIG. 3) coupled between a VIN node and a VSW node, a third transistor (e.g., transistor Q3) and a fourth transistor (e.g., transistor Q4) coupled between the VSW node and a reference potential node (e.g., electric ground), and an inductive element (e.g., L1 of FIG. 3) coupled between the VSW node and a VOUT node. In some aspects, the three-level buck converter may also include a CFLY with a first terminal coupled to a node between the first transistor and the second transistor and a second terminal coupled to a node between the third transistor and the fourth transistor.

At block 604, the controller may turn on the first transistor and the second transistor for at least one first cycle (e.g., as opposed to turning on the first transistor and the third transistor during a charging phase) based on the occurrence of the event. At block 606, the controller may turn on the second transistor and the fourth transistor for a second cycle (e.g., a discharging phase) after the at least one first cycle.

In some aspects, the controller may turn on the third transistor and the fourth transistor between the at least one first cycle and the second cycle (e.g., during a freewheeling phase). In some aspects, the controller may turn on the first transistor and the third transistor during a third cycle (e.g., charging phase) after the second cycle.

In some aspects, the controller may compare (e.g., via comparator 380) a VOUT at the VOUT node to a voltage droop reference voltage (e.g., Vdroop_ref) and generate a voltage droop detection signal (e.g., Vdroop_detect) based on the comparison. The occurrence of the event may be identified based on the voltage droop detection signal.

In some aspects, the controller may enter a light load mode during which the first transistor, the second transistor, the third transistor, and the fourth transistor are turned off. The occurrence of the event may include exiting the light load mode. For example, the controller may receive, via an error amplifier (e.g., error amplifier 305), a reference voltage (e.g., VREF) and a feedback voltage (e.g., VFB) based on a VOUT at the VOUT node. The controller may generate an error voltage (V error) based on the reference voltage and the feedback voltage. The light load mode may be entered based on the error voltage dropping below a voltage threshold.

In some aspects, the controller may turn on the first transistor and the second transistor to set a VSW at the VSW node equal to VIN at the VIN node during the at least one first cycle. A rising slope of a current across the inductive element during the at least one first cycle may be greater than a rising slope of the current across the inductive element during the second cycle.

### Example Aspects

In addition to the various aspects described above, specific combinations of aspects are within the scope of the disclosure, some of which are detailed below:

Aspect 1: A power supply circuit comprising: a three-level buck converter comprising a first transistor and a second transistor coupled between an input voltage (VIN) node and a switching voltage (VSW) node, a third transistor and a fourth transistor coupled between the VSW node and a reference potential node, and an inductive element coupled between the VSW node and an output voltage (VOUT) node; and a controller configured to: identify an occurrence of an event associated with an increase in current draw from a load of the three-level buck converter; turn on the first transistor and the second transistor for at least one first cycle based on the occurrence of the event; and turn on the second transistor and the fourth transistor for a second cycle after the at least one first cycle.

Aspect 2: The power supply circuit of Aspect 1, wherein the controller is further configured to turn on the third transistor and the fourth transistor between the at least one first cycle and the second cycle.

Aspect 3: The power supply circuit of Aspect 1 or 2, wherein the controller is further configured to turn on the first transistor and the third transistor during a third cycle after the second cycle.

Aspect 4: The power supply circuit according to any of Aspects 1-3, further comprising a comparator configured to compare a VOUT at the VOUT node to a voltage droop reference voltage and generate a voltage droop detection signal based on the comparison, wherein the controller is configured to identify the occurrence of the event based on the voltage droop detection signal.

Aspect 5: The power supply circuit according to any of Aspects 1-4, wherein: the three-level buck converter is configured to enter a light load mode during which the first transistor, the second transistor, the third transistor, and the fourth transistor are turned off; and the occurrence of the event comprises the three-level buck converter exiting the light load mode.

Aspect 6: The power supply circuit of Aspect 5, further comprising an error amplifier configured to: receive a reference voltage and a feedback voltage, the feedback voltage being based on a VOUT at the VOUT node; and generate an error voltage based on the reference voltage and the feedback voltage, wherein the controller is configured to enter the light load mode based on the error voltage dropping below a voltage threshold.

Aspect 7: The power supply circuit according to any of Aspects 1-6, further comprising a flying capacitive element (CFLY) with a first terminal coupled to a node between the first transistor and the second transistor and a second terminal coupled to a node between the third transistor and the fourth transistor.

Aspect 8: The power supply circuit according to any of Aspects 1-7, wherein a VSW at the VSW node is set to be equal to VIN at the VIN node during the at least one first cycle.

Aspect 9: The power supply circuit according to any of Aspects 1-8, wherein a rising slope of a current across the inductive element during the at least one first cycle is greater than a rising slope of the current across the inductive element during the second cycle.

Aspect 10: A method of controlling a power supply circuit, comprising: identifying an occurrence of an event associated with a load of a three-level buck converter, the three-level buck converter comprising a first transistor and a second transistor coupled between an input voltage (VIN) node and a switching voltage (VSW) node, a third transistor and a fourth transistor coupled between the VSW node and a reference potential node, and an inductive element coupled between the VSW node and an output voltage (VOUT) node; turning on the first transistor and the second transistor for at least one first cycle based on the occurrence of the event; and turning on the second transistor and the fourth transistor for a second cycle after the at least one first cycle.

Aspect 11: The method of Aspect 10, further comprising turning on the third transistor and the fourth transistor between the at least one first cycle and the second cycle.

Aspect 12: The method of Aspect 10 or 11, further comprising turning on the first transistor and the third transistor during a third cycle after the second cycle.

Aspect 13: The method according to any of Aspects 10-12, further comprising: comparing a VOUT at the VOUT node to a voltage droop reference voltage; and generating a voltage droop detection signal based on the comparison, wherein the occurrence of the event is identified based on the voltage droop detection signal.

Aspect 14: The method according to any of Aspects 10-13, further comprising entering a light load mode during which the first transistor, the second transistor, the third transistor, and the fourth transistor are turned off, wherein the occurrence of the event includes exiting the light load mode.

Aspect 15: The method of Aspect 14, further comprising: receiving, via an error amplifier, a reference voltage and a feedback voltage, the feedback voltage being based on a VOUT at the VOUT node; and generating an error voltage based on the reference voltage and the feedback voltage, the light load mode being entered based on the error voltage dropping below a voltage threshold.

Aspect 16: The method according to any of Aspects 10-15, further comprising a flying capacitive element (CFLY) with a first terminal coupled to a node between the first transistor and the second transistor and a second terminal coupled to a node between the third transistor and the fourth transistor.

Aspect 17: The method according to any of Aspects 10-16, wherein turning on the first transistor and the second transistor comprises setting a VSW at the VSW node equal to VIN at the VIN node during the at least one first cycle.

Aspect 18: The method according to any of Aspects 10-17, wherein a rising slope of a current across the inductive element during the at least one first cycle is greater than a rising slope of the current across the inductive element during the second cycle.

Aspect 19: A three-level buck converter comprising: a first transistor and a second transistor coupled between an input voltage (VIN) node and a switching voltage (VSW) node; a third transistor and a fourth transistor coupled between the VSW node and a reference potential node; and an inductive element coupled between the VSW node and an output voltage (VOUT) node, wherein: the first transistor and the second transistor are configured to be turned on for at least one first cycle based on identifying an occurrence of an event associated with an increase in current draw from a load of the three-level buck converter; and the second transistor and the fourth transistor are configured to be turned on for a second cycle after the at least one first cycle.

Aspect 20: The three-level buck converter of Aspect 19, wherein the first transistor and the third transistor are configured to be turned on during a third cycle after the second cycle.

The various operations of methods described above may be performed by any suitable means capable of performing the corresponding functions. The means may include various hardware and/or software component(s) and/or module(s), including, but not limited to a circuit, an application-specific integrated circuit (ASIC), or a processor. Generally, where there are operations illustrated in figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A power supply circuit comprising:
a three-level buck converter comprising a first transistor and a second transistor coupled between an input voltage (VIN) node and a switching voltage (VSW) node, a third transistor and a fourth transistor coupled between the VSW node and a reference potential node, and an inductive element coupled between the VSW node and an output voltage (VOUT) node; and
a controller configured to:
identify an occurrence of an event associated with an increase in current draw from a load of the three-level buck converter;
turn on the first transistor and the second transistor for at least one first cycle based on the occurrence of the event; and
turn on the second transistor and the fourth transistor for a second cycle after the at least one first cycle.

2. The power supply circuit of claim 1, wherein the controller is further configured to turn on the third transistor and the fourth transistor between the at least one first cycle and the second cycle.

3. The power supply circuit of claim 1, wherein the controller is further configured to turn on the first transistor and the third transistor during a third cycle after the second cycle.

4. The power supply circuit of claim 1, further comprising a comparator configured to compare a VOUT at the VOUT node to a voltage droop reference voltage and generate a voltage droop detection signal based on the comparison, wherein the controller is configured to identify the occurrence of the event based on the voltage droop detection signal.

5. The power supply circuit of claim 1, wherein:
the three-level buck converter is configured to enter a light load mode during which the first transistor, the second transistor, the third transistor, and the fourth transistor are turned off; and
the occurrence of the event comprises the three-level buck converter exiting the light load mode.

6. The power supply circuit of claim 5, further comprising an error amplifier configured to:
receive a reference voltage and a feedback voltage, the feedback voltage being based on a VOUT at the VOUT node; and
generate an error voltage based on the reference voltage and the feedback voltage, wherein the controller is configured to enter the light load mode based on the error voltage dropping below a voltage threshold.

7. The power supply circuit of claim 1, further comprising a flying capacitive element (CFLY) with a first terminal coupled to a node between the first transistor and the second transistor and a second terminal coupled to a node between the third transistor and the fourth transistor.

8. The power supply circuit of claim 1, wherein a VSW at the VSW node is set to be equal to VIN at the VIN node during the at least one first cycle.

9. The power supply circuit of claim 1, wherein a rising slope of a current across the inductive element during the at least one first cycle is greater than a rising slope of the current across the inductive element during the second cycle.

10. A method of controlling a power supply circuit, comprising:
identifying an occurrence of an event associated with a load of a three-level buck converter, the three-level buck converter comprising a first transistor and a second transistor coupled between an input voltage (VIN) node and a switching voltage (VSW) node, a third transistor and a fourth transistor coupled between the VSW node and a reference potential node, and an inductive element coupled between the VSW node and an output voltage (V OUT) node;
turning on the first transistor and the second transistor for at least one first cycle based on the occurrence of the event; and
turning on the second transistor and the fourth transistor for a second cycle after the at least one first cycle.

11. The method of claim 10, further comprising turning on the third transistor and the fourth transistor between the at least one first cycle and the second cycle.

12. The method of claim 10, further comprising turning on the first transistor and the third transistor during a third cycle after the second cycle.

13. The method of claim 10, further comprising:
comparing a VOUT at the VOUT node to a voltage droop reference voltage; and
generating a voltage droop detection signal based on the comparison, wherein the occurrence of the event is identified based on the voltage droop detection signal.

14. The method of claim 10, further comprising entering a light load mode during which the first transistor, the second transistor, the third transistor, and the fourth transistor are turned off, wherein the occurrence of the event includes exiting the light load mode.

15. The method of claim 14, further comprising:
receiving, via an error amplifier, a reference voltage and a feedback voltage, the feedback voltage being based on a VOUT at the VOUT node; and
generating an error voltage based on the reference voltage and the feedback voltage, the light load mode being entered based on the error voltage dropping below a voltage threshold.

16. The method of claim 10, further comprising a flying capacitive element (CFLY) with a first terminal coupled to a node between the first transistor and the second transistor and a second terminal coupled to a node between the third transistor and the fourth transistor.

17. The method of claim 10, wherein turning on the first transistor and the second transistor comprises setting a VSW at the VSW node equal to VIN at the VIN node during the at least one first cycle.

18. The method of claim 10, wherein a rising slope of a current across the inductive element during the at least one first cycle is greater than a rising slope of the current across the inductive element during the second cycle.

19. A three-level buck converter comprising:
a first transistor and a second transistor coupled between an input voltage (VIN) node and a switching voltage (VSW) node;
a third transistor and a fourth transistor coupled between the VSW node and a reference potential node; and
an inductive element coupled between the VSW node and an output voltage (VOUT) node, wherein:
the first transistor and the second transistor are configured to be turned on for at least one first cycle based on identifying an occurrence of an event associated with an increase in current draw from a load of the three-level buck converter; and
the second transistor and the fourth transistor are configured to be turned on for a second cycle after the at least one first cycle.

20. The three-level buck converter of claim 19, wherein the first transistor and the third transistor are configured to be turned on during a third cycle after the second cycle.
